(19) United States
(12) Patent Application Publication
(10) Pub. No.: US 2014/0315174 A1
(43) Pub. Date: Oct. 23, 2014

(54) UNIVERSAL MICROSURGICAL SIMULATOR

(71) Applicant: The Penn State Research Foundation, University Park, PA (US)

(72) Inventors: Joseph Sassani, Hershey, PA (US); Roger Webster, Millersville, PA (US); Michael Fiorill, Lancaster, PA (US)

(73) Assignee: THE PENN STATE RESEARCH FOUNDATION, University Park, PA (US)

(21) Appl. No.: 14/357,923

(22) PCT Filed: Nov. 23, 2012
(86) PCT No.: PCT/US2012/066447

§ 371 Date: May 13, 2014

Related U.S. Application Data
(60) Provisional application No. 61/563,353, filed on Nov. 23, 2011.
(60) Provisional application No. 61/563,376, filed on Nov. 23, 2011.

(51) Int. Cl. G09B 23/28

(52) U.S. Cl. CPC G09B 23/28
USPC 434/262

(57) ABSTRACT

A microsurgical simulation system includes a display for providing a virtual simulation of images of a model of a human eye and a hand-held tool for simulating a surgical tool. The hand-held tool comprises a position and orientation sensor for supplying positional signals to a processor to indicate a position and orientation of the hand held tool and a tracking system for supplying measurement signals to the processor to indicate a linear distance between a first component and a second component of the hand-held tool. A virtual representation of the hand-held tool is presented on the display, and the appearance and positioning of the virtual representation of the hand-held tool is based on the positional signals and measurement signals supplied to the processor by the hand-held device.

### CROSS-REFERENCE TO RELATED APPLICATIONS

This application claims the benefit of provisional application Ser. No. 61/563,353, filed Nov. 23, 2011, and provisional application Ser. No. 61/563,376, filed Nov. 23, 2011.

### STATEMENT OF GOVERNMENT SUPPORT

This invention was made with government support under Contract No. W81XWH-10-2-0019, awarded by the U.S. Army/MRMC. The Government has certain rights in the invention.

### BACKGROUND OF THE INVENTION

1. Field of the Invention

The present invention relates to improvements in methods and tools used for surgery simulations. More particularly the invention relates to easy to software and hardware for a microsurgery simulation tool.

2. Description of the Related Art

Eye injuries resulting in corneal or scleral lacerations occur in a variety of civilian and military settings. Skilled closure of such injuries is a key to healing and rehabilitating the injured eye. Unfortunately, during residency training, ophthalmologists have decreasing exposure to ocular microsurgical suturing because of changes in cataract surgery techniques. Moreover, those who assess surgical skills of Boarded surgeons, and those who accredit surgical educational programs are demanding documentation of trainee competency.

Virtual reality simulation has been postulated to be useful for these purposes. Yet, simulators adequate to the task do not exist. Therefore, in addition to patients themselves, those who might benefit from simulation are residency training programs in ophthalmology, neurosurgery, vascular surgery, etc., as well as hospitals, and the military where surgical skills need to be refreshed, competency tested, and where new surgical procedures need to be learned.

The traditional apprenticeship training model (simplified as “See one, do one, teach one”) has been the standard method of surgical education for many years. This educational paradigm has many risks and deficiencies relative to the present surgical learning environment including:
1. An unstructured curriculum dependent upon the vagaries of patient flow particularly regarding ocular trauma;
2. Significant financial costs;
3. Human costs including potential threats to patient health; and
4. Unmanageable time constraints in the face of limited trainee availability resulting from multiple types of time demands and regulatory restrictions on resident physician workload.

Resident surgical experience is correlated with the rate of untoward surgical events or unsuccessful surgical results. For example, there is a definite “learning curve” in the education of Ophthalmology residents in cataract surgery. Microsurgical simulation holds the promise of truncating that learning curve and, potentially, decreasing the incidence of complications during surgery. Such microsurgical simulation would be expected to be of particular value for procedures that are heavily dependent on microsurgical technique, but which are performed relatively infrequently such as the repair of corneal or scleral lacerations, or corneal transplantation.

Those who assess surgical skills of Board Certified Surgeons, and those who accredit surgical educational programs are demanding documentation of competency on the part of the trainee rather than simply demonstrating the presence of educational infrastructure and exposure to didactics or procedures. Unfortunately, adequate tools for assessing such lab competency, particularly in microsurgery, remain to be devised. Microsurgical lab evaluations are one technique suggested for such evaluations.

The ACGME (the accrediting body for all residency training programs) states in its “Program Requirements for Graduate Medical Education in General Surgery” that institutional resources for training surgical residents “ . . . must include simulation and skills laboratories. These facilities must address acquisition and maintenance of skills with a competency based method of evaluation.”

As pointed out there are specific needs for microsurgery simulation in Ophthalmology. Ophthalmology is one particular field that has a critical need for microsurgical simulators due to the lack of surgical training experiences available for ocular trauma. Below is a list of some specific areas in Ophthalmology that have a need for microsurgical simulators.
1. Civilian Ocular Trauma: It is estimated that the incidence of penetrating eye injuries (those injuries that enter the eye) in the United States is 3.1 per 100,000 person-years. The key to rehabilitation of these eyes is early, initial expert microsurgical repair.
2. Military Combat Ocular Trauma: Similarly, the military has a particular need for a surgery simulator. There has been a progressive increase in the incidence of Combat eye injuries from the Civil War to the present day. Although body armor has saved many warfighters from fatal injuries, and polycarbonate protective eyewear may prevent some ocular trauma, all too frequently warfighters survive a blast only to be left with permanent disability from severe eye injuries. Unlike other forms of injuries that can be temporarily stabilized, ocular injuries often require immediate microsurgical repair if the globe is to be salvaged for subsequent reconstructive procedures, such as vitrectomy or retinal reattachment surgery, and to prevent intraocular infections. Such infections (endophthalmitis) are much more devastating to ocular function than they would be to many other tissues and organs. The cornerstone of successful ocular trauma triage and treatment is rapid and expert primary repair of the initial “open globe” injury near the field of combat, followed by definitive reconstructive ophthalmic surgery, including foreign body removal, at centers such as Walter Reed Army Medical Center or Brooke Army Medical Center. Unfortunately, although all ophthalmologists have some experience with open globe trauma surgery during residency training, many of them will have had no recent experience in such trauma surgery prior to military deployment due to the infrequent occurrence of such injuries in ophthalmic practice even in the stateside military setting, or to subsequent training in an unrelated ophthalmic subspecialty. Therefore, there is a need to provide military ophthalmologists with efficient means to refresh and enhance microsurgical skills, particularly related to ocular trauma.
3. Non-combat Military Ocular Trauma: The average annual incidence of hospitalization for a principal or secondary diagnosis military ocular trauma is 77.1 per 100,000 persons. Only 7% of these injuries are related to weaponry or war, and of these, 90% are from non-battle activities.
4. Veterans Health Care System: The Department of Veterans Affairs supports 8,700 resident positions nationally. Veterans Administration Hospitals are an integral component of America's surgical education system. Moreover, as noted by Longo and associates, “Of the four missions of the Department of Veterans Affairs, research and education is essential to provide quality, state of the art clinical care to the veteran.” The benefits of affiliations between academic medical centers and Veterans Administration hospitals to the quality of care for veterans have been cited by others. The patient populations at Veterans Administration hospitals with academic affiliations are more likely to have higher risk factors and to undergo more complex surgical procedures. Therefore, measures that increase surgical resident educational efficiency and quality are particularly likely to impact our Veteran population.
5. Surgical Skills Challenges in Ophthalmology: A recent survey of Ophthalmology residency graduates found that ⅔ felt that they needed additional surgical training. Ophthalmology may be even more vulnerable to the flaws of the apprenticeship approach to surgical education because of the specialty's dependence on microsurgical techniques and its constant influx of new technologies. Moreover, it may become necessary to test skills required for the development of competency during the resident selection process. Such tests may avoid some of the difficulties encountered by residency graduates who, nonetheless, have difficulty acquiring surgical skills during their residency years (presently, an Ophthalmology residency program cannot certify a “non-surgical” Ophthalmologist). The impact of these trends on ophthalmic education is compounded by the fact that, in recent years, the predominant technique of wound creation for cataract surgery has shifted to a sutureless, “clear corneal” approach. As a result, today, Ophthalmology residents much less frequently place sutures in a non-trauma-related microsurgical environment whereas previously, microsurgical suturing at the corneal-scleral junction (limbus) was the standard procedure during cataract surgery. Thus, today's graduating Ophthalmologists have had much less experience in microsurgical suturing techniques when they eventually are called upon to repair traumatic wounds of the cornea or sclera. Nevertheless, the treatment of ocular trauma has been listed as one of the most important skills to be acquired by the Ophthalmology resident.

Thus there is a need for a simulator device that enables Ophthalmologists to meet the need for improved surgical care of ocular injuries in civilian, military, and Veterans Administration settings, contributing to increased quality of care of ocular trauma patients.

### BRIEF SUMMARY OF THE INVENTION

We provide a Universal Microsurgical Simulator. The simulator may aid in the instruction of ophthalmology residents in the microsurgical repair of lacerations and perforations of the cornea and sclera, and will refresh the skills of experienced surgeons in these areas. Additionally, the same system's universal features that permit it to be used to train ophthalmology residents in other microsurgical procedures, or modified to train or refresh the skills of microsurgeons in other surgical subspecialties (e.g. neurosurgery, vascular surgery, and plastic surgery). Therefore, it will be understood that throughout this disclosure the various embodiments of the invention should not be limited to ocular surgery unless explicitly stated as such in the claims.

It is anticipated that the microsurgical simulator will become an integral part of the accredited surgical education process and competence evaluation for Board Certified Surgeons. Thus, our simulator will provide an opportunity to truncate the microsurgical learning curve for residents in training and allow an opportunity for experienced surgeons to enhance their microsurgical skills or to learn new skill sets. Furthermore, the system is flexible so that it can be adapted for the training of surgeons in other specialties such as Vascular Surgery, Neurosurgery, and Plastic Surgery.

A microsurgical simulation system is disclosed here that has a display for providing a virtual simulation of images of a part of a simulated human to be subject to simulated microsurgery and a hand-held tool for simulating a surgical tool. The hand-held tool has a position and orientation sensor for supplying positional signals to a processor to indicate a position and orientation of the hand held tool. The hand-held tool also has a tracking system for supplying measurement signals to the processor to indicate a linear distance between a first component and a second component of the hand-held tool.

A virtual representation of the hand-held tool is presented on the display and the appearance and positioning of the virtual representation of the hand-held tool is based on the positional signals and measurement signals supplied to the processor by the hand-held device.

In another embodiment of the microsurgical simulation system, the hand-held tool is forceps.

In yet another embodiment of the microsurgical simulation system, the tracking system is a digital encoder.

In still another embodiment of microsurgical simulation system, the digital encoder determines the linear distance between the first component and the second component of the hand-held tool based on contactless optical sensors attached to the hand-held tool.

In a further embodiment of the microsurgical simulation system, the system further comprises a model of a human head.

In a further embodiment of the microsurgical simulation system, the system further comprises a camera and a foot pedal that controls the camera.

In yet a further embodiment of the microsurgical simulation system, the part of a simulated human to be subject to simulated microsurgery is an eye.

A microsurgical simulation tool is also disclosed herein that has a hand-held tool for simulating a surgical tool. The hand-held tool has a position and orientation sensor for supplying positional signals to a processor to indicate a position and orientation of the hand held tool and a tracking system for supplying measurement signals to the processor to indicate a linear distance between a first component and a second component of the hand-held tool.

A virtual representation of the hand-held tool is presented on a display and the appearance and positioning of the virtual representation of the hand-held tool is based on the positional signals and measurement signals supplied to the processor by the hand-held device.

In another embodiment of the microsurgical simulation tool, the hand-held tool is forceps, tweezers, or needle holders.

In yet another embodiment of the microsurgical simulation tool, the tracking system is a digital encoder.

In still another embodiment of the microsurgical simulation tool, the digital encoder determines the linear distance between the first component and the second component of the hand-held tool based on contactless optical sensors attached to the hand-held tool.

### BRIEF DESCRIPTION OF THE FIGURES

In the accompanying drawing I have shown certain present preferred embodiments of our Universal Microsurgical Simulator in which:

FIG. 1 shows an embodiment of a system used in training microsurgical techniques during ocular surgical processes.

FIGS. 2-5 and 7 show forceps modeled as a microsurgical simulation tool. FIGS. 2-4 are exploded views.

FIG. 6 shows an image of a simulated lid speculum in place while a knot is tied on a lower eyelid.

FIG. 8 shows a model of a human head that is used to provide correspondence between a model of a real life patient and a virtual representation of a human face in a microsurgical simulation.

FIG. 9 shows two renderings of a surgical simulation, a top and a bottom, using a 3-dimensional screen.

FIG. 10 shows a sample of a software update loop.

FIG. 11 shows an illustration of various surgical knots.

FIG. 12 shows an algorithm for manipulation of various string segments.

FIG. 13 shows an example of an interface screen for a simulator of one embodiment of the invention.

### DESCRIPTION OF THE PREFERRED EMBODIMENTS

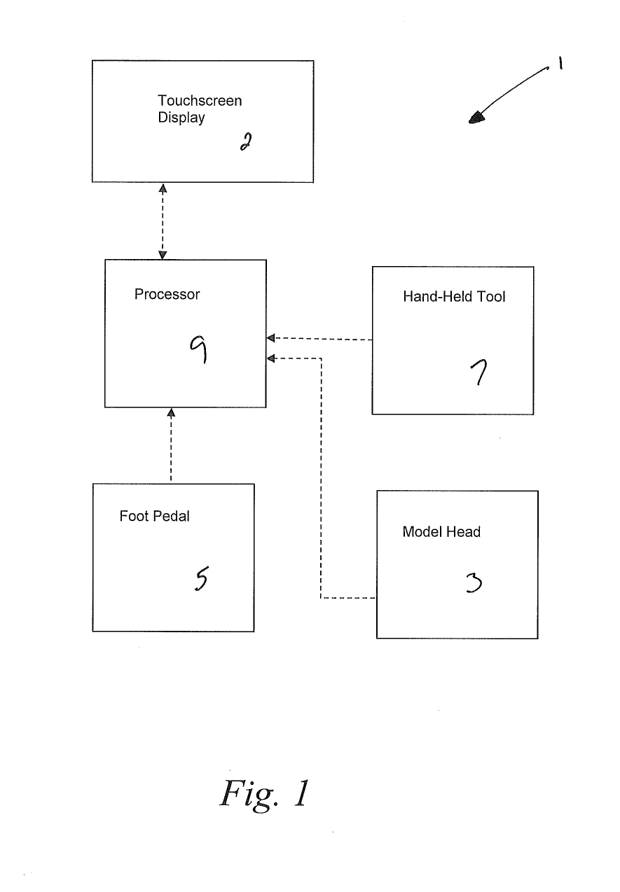

An overall general description of preferred embodiments of a Universal Microsurgical Simulator is provided herein. The Universal Microsurgical Simulator system 1 show in FIG. 1 provides multiple components that may be used to provide a virtual microsurgical environment. The preferred embodiment shown in FIG. 1 is for a system used in training microsurgical techniques during ocular surgical processes. However, the present invention is not limited to ocular surgical processes but can be used as a training system for any number of microsurgical processes. As can be seen in FIG. 1, the system may include a display 2 or displays for presenting a virtual simulation, a physical model 3 of a human head and eye to be used as physical points of reference, a foot pedal 5 to control a virtual camera, and a hand-held tool 7 that is to be modeled in a virtual environment. The inputs from the foot pedal 5, hand-held tool 7, and physical model 3 are provided to a processor 9 or processing device that provides an output to the display 2. The display 2 may be either a touchscreen device or a non-touch sensitive device. Therefore, the processor 9 may also receive inputs from the display 1 itself.

The Universal Microsurgical Simulator system 1 allows a user to simulate handheld tools that can be used in microsurgery, small assembly, or any task where a hand-held tool such as tweezers, forceps, scissors, or other tools are to be used. The hardware of the system uses a common tool body upon which tips can be mounted to simulate a particular use. Tips can be fabricated that mimic tweezers, forceps, scissors, and other handheld tools that require a pinching or squeezing finger action to operate.

The software and/or hardware components of the Universal Microsurgical Simulator system 1 provide a virtual environment for a microsurgical task that is to be accomplished. Other tasks directed to use of hand-held tools such as tweezers, forceps, and scissors can also be accomplished. A preferred embodiment describing the function and use of hardware and software in an ocular microsurgical setting is described herein.

Several different instruments may be used by a surgeon during surgery, in particular during a suturing process. For example, any or all of curved forceps, straight forceps, and needle holders may be used in a suturing procedure. The curved forceps, straight forceps, and needle holder are used to tie knots during surgery. Thus, the Universal Microsurgical Simulator is capable of modeling each of these hand-held tools in a virtual, microsurgical environment, as well as modeling knots. The Universal Microsurgical Simulator allows tool swapping to be done virtually rather than both physically and virtually.

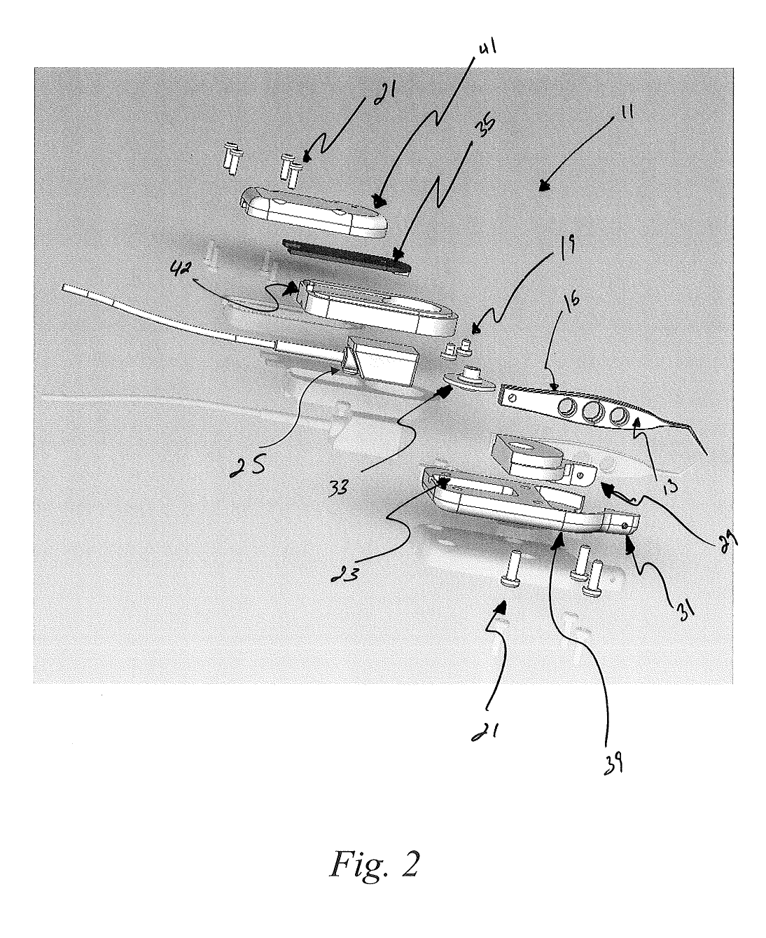

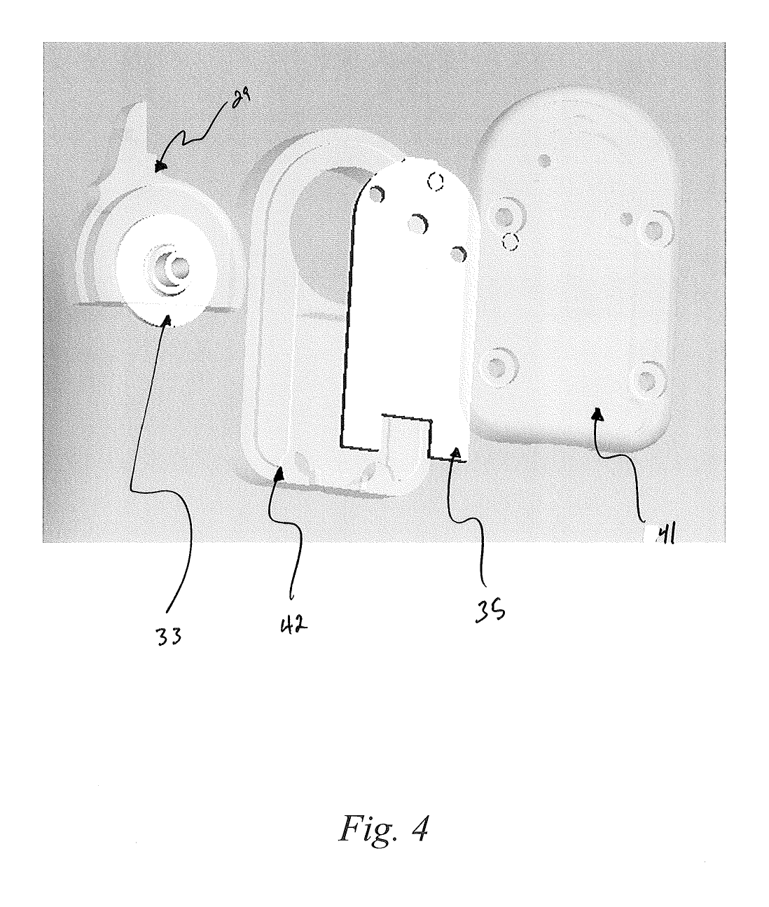

In the preferred embodiment shown in FIGS. 2-5, surgical forceps have been modeled as a hand-held tool 11. The hand-held tool is used for simulating any desired surgical tool, such as for example those discussed above. This may be the case even though the outward, non-virtual appearance of the tool is as forceps. The physical appearance and mechanical feel of the tips can be altered easily by installing customizable tips onto the microsurgical tool body.

In one embodiment, a hand-held tool 11 includes a position and orientation sensor for supplying positional signals to a processor to indicate a position and orientation of the hand held tool 11 and a tracking system for supplying measurement signals to the processor to indicate a linear distance between a first component 13 and a second component 15, or tips, of the hand-held tool 11. The processor may be located locally, such as in the instance that the Universal Microsurgical Simulator is embodied as a computer running the software requirements and the hand held tool in a user's office. A processor may also be implemented in a server controlled system where processing functions are performed at a location that is not necessarily the same as the other components of the Universal Microsurgical Simulator. In either case, a display(s) is typically provided that shows a virtual simulation of images of a model eye.

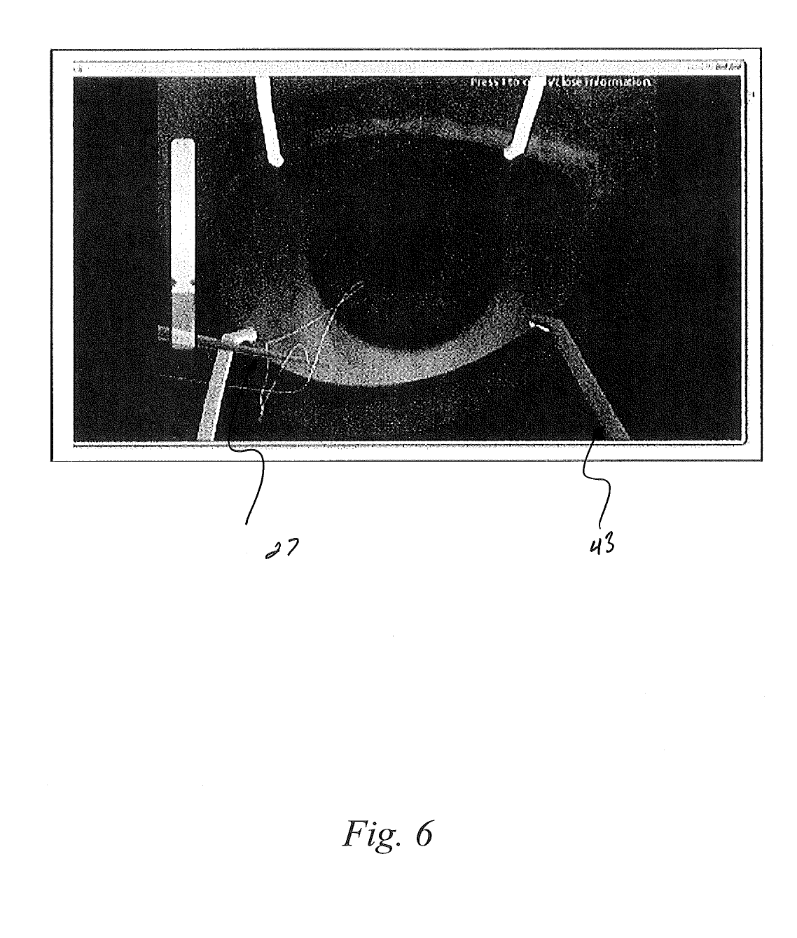

A virtual representation of the hand-held tool 11 is presented on the display such that the appearance and positioning of the virtual representation of the hand-held tool is based on the positional signals and measurement signals supplied to the processor by the hand-held device. Thus, as seen in FIG. 6, the hand-held tool 11 will be presented in a spatial relationship to the virtual model of the eye based on inputs of from the hand-held device 11.

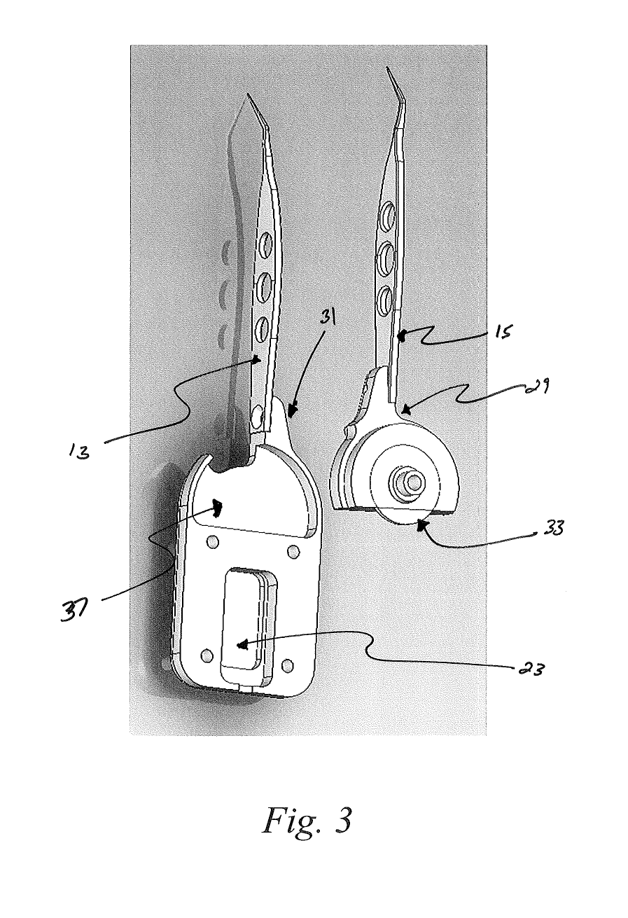

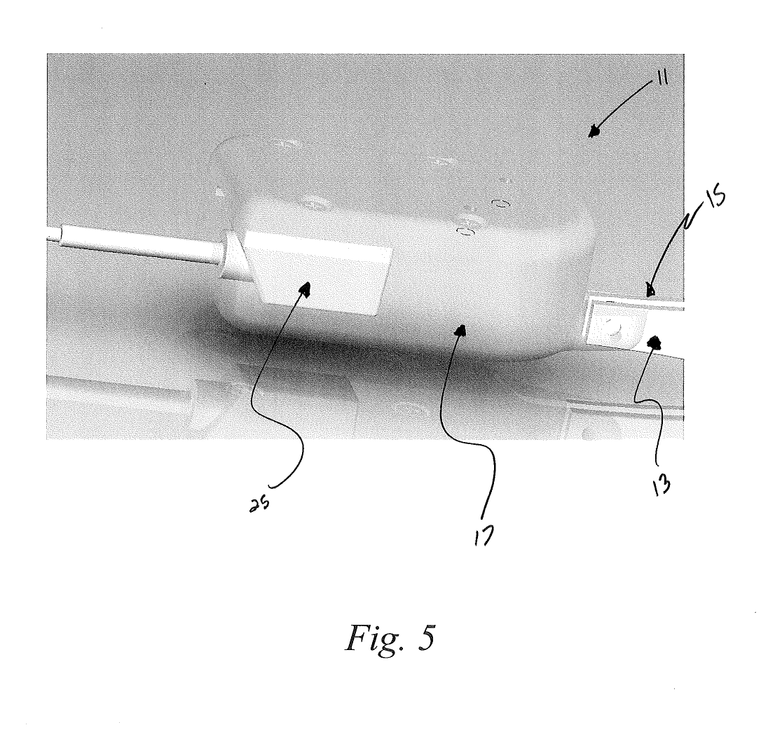

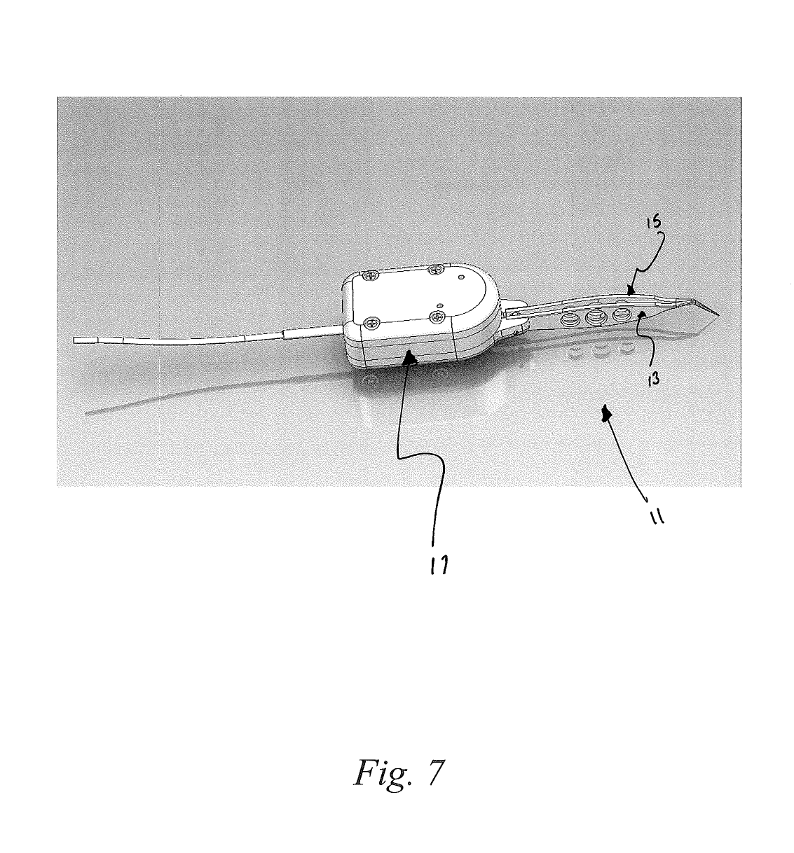

As shown in FIG. 3, the attachment points of the tips 13, 15 of the forceps may be made at the lowest part of the tool body so the hand-held tool would rest comfortably between the thumb and index finger while allowing the tips 13, 15 to be manipulated in a natural position. The tools may be designed and machined to create a monocoque design as shown in FIGS. 5 and 7. A preferred monocoque design allows for ample, unobstructed area inside the tool body for embedding sensors, optics, and electronics. Using this methodology, the case 17 of the tool body can act as both an active electromechanical-optical component of the system and a highly precise, active, load-bearing structure. The case 17 may be made of multiple components, such as an internal housing 42 and outer housings 39, 41 as shown in FIGS. 2-4. Optics and electronics may be embedded into the case 17; creating a structure that also acts as multiple sleeve bearings and as a cable support. Thus, the entire device may act as a sophisticated encoder module. This feature allows for increased accuracy, as rotational optics used to measure the tip angle may be sensitive to deflections, such as in the sub-millimeter range.

Additionally, the case of the hand-held tool can be fabricated from a resilient, self-lubricating material. For example, the tool body can be made of a strong, self-lubricating polyoxymethylene material called Delrin® to withstand various types of chemical contact as well as oils from the human users' skin. The Delrin® material also has self-lubricating properties, thus requiring no preventative maintenance on the hand-held tool. All metal parts, such as pins 19, screws 21, and tips 13, 15 may be made out of stainless steel to provide maximum resistance to corrosion and rust.

Embedded in the hand-held tool 11 are sensors that allow the simulation program to understand the positioning, orientation, movement, and state of the hand-held tool in the real world. The simulator needs the position and orientation of each instrument in order to correctly simulate the instrument moving in the virtual world. A six degree-of-freedom (6-DOF) tracking sensor 25 gives six degrees of freedom orientation as well as relative position based on magnetic impulses between a base sensor and two movable sensors. The 6-DOF sensor 25 is used to obtain the orientation and position of the hand-held tool that is being modeled.

A sensor pocket 23 is machined inside the body of the hand-held tool 11 to hold the 6-DOF sensor system 25. This sensor 25 monitors the position of the tool body in three-dimensional space (x, y, and z), as well as the orientation of the tool body (pitch, row, and yaw). An example of such a sensor may be the Patriot sensor manufactured by Polhemus. Modeling surgery requires accurate position in terms of the X, Y, and Z planes, and orientation (pitch, roll, and yaw) of the hand-held tool that is intended to be modeled. The position and orientation of the 6-DOF tracking sensor 25 provide an accurate representation of a virtual model 27 of the currently selected hand-held tool. The degree of open and close of the tips 13, 15 of the hand-held tool 11 is based on the optical sensor's extrapolation. Additionally, the closer the tool extensions are, the less of a rotation is placed on each of the tool sides.

In one embodiment, the hand-held tool 11 has forceps tips that are spring-loaded in the tool body and have 8 mm of space between the tip ends. One tip 15 is mounted to a rotating platform. The other 13 is attached to a fixed point on the tool body. As the user squeezes the tips together the tip attached to the rotating platform 29 moves that platform around a central axis. This also causes rotation of the optical disc 33, which is embedded in the rotating platform 29. A printed circuit board (PCB) 35, with optics, may be permanently affixed inside the tool body. Thus the rotating disc 33 changes relative to the fixed circuit board 35 as the tips 13, 15 are compressed together. As an example, the rotating disc may have 128 reflective lines and 128 black lines on it. Optics comprising a light source and two light receivers are located on the PCB 35 and the light receivers digitally track the reflections and light absorption by the lines on the optical disc.

Through a process known as “quadrature encoding” each pair of light-absorbing and light-reflecting lines generate four discreet signals into the two light receivers located on the PCB 35. Four pairs of lines create 16 distinct levels of open and close of the tool tips. Thus, the Universal Microsurgical Simulator can digitally measure how many millimeters the tips are open based on the distinct digital feedback from the optical disc. Resolution of open and close is limited only by the resolution of the optics used.

In a preferred embodiment a Universal Microsurgical Simulator can precisely measure linear distance between the tips of a hand-held tool utilizing a tracking system that may consist of a digital encoder. In the preferred embodiment shown in FIGS. 2-5, one tool tip is mounted to a moveable platform 29 and another tip is attached to fixed platform 23. A code wheel 33, magnet, or other rotational encoder component is embedded in this platform. The moveable platform 29 fits in a pocket 37, that may be machined, that limits its movement to the open and close limits of the design of the tips 13, 15 of the particular hand-held tool being used; for example, a pair of tweezers or forceps. A spring presses between the pocket 37 and the moveable platform 29, thus always returning the moveable platform 29 to an initial position after the tool tips 13, 15 are released.

The moveable platform 29 has a central rotational point with a machined pin 19 inserted through it. This pin 19 fits into machined holes located in the outer housing 39, 41 that act like sleeve bearings. Acetyl may be used for the housing body for its self-lubricating properties. This facilitates a maintenance-free, self-lubricating, bearing system that is integral to the design.

A printed circuit board (PCB) 35 with integral encoder tracking module is affixed to the inside of the body of the hand-held tool 11. As the moveable platform 29 rotates relative to the body of the hand-held tool 11, during tip perturbation by the operator, an encoder module located on the PCB 35 tracks changes in optical properties for an optical absolute or incremental encoder; or the change in magnetic flux for a magnetic absolute or incremental encoder. These signals are then processed by an onboard microcontroller and reported to a host computer system via USB, serial or parallel inputs, or other form of communication such as infrared or other forms of wireless communication. Of course, it will be understood that USB is not a required connection modality, and that other standards (including but not limited to wireless standards) may be used.

The tracking system may consist of optical sensors to assess the degree of separation of the tips 13, 15 of the hand-held tool 11. In a preferred embodiment, contactless optical tracking sensors are used that have been developed specifically for medical simulation. The tracking system measures the open and close degree of instrument tips 13, 15 without interfering with the electromagnetic signals of the 6-DOF sensor system that are used to report the position and orientation of the hand-held tool 11. The tracking system may also include a device or devices that calculate the degree of separation of the hand-held tool 11 based on changes in magnetic flux. However, the use of optics helps to eliminate errors that can be introduced by potentiometers or other devices that may emit electromagnetic fields. Because there is no direct contact between the measurement parts of the tracking system, the optical solution also provides a virtually limitless lifetime, unlike traditional designs.

With the tracking system, the hand-held tool 11 gives an input of how open or closed the hand-held tool 11 is in the surgeon's hand. In some embodiments there may be as many as 16 extrapolations or more that an optical sensor senses from the hand-held tool. These extrapolations are based on the distance between base ends of the tool. This information, combined with the 6-DOF sensor system orientation and relative position information, provides all the details necessary to virtually represent any eye surgery tool.

Overall, durable materials can be selected such that the lifespan and reliability of the tools is increased. These include, for example, Delrin® and stainless steel.

A Universal Microsurgical Simulator system 1 may also include a virtual microscope connected to a foot pedal which is used for viewing a patient's eye or other surgery target in the simulation. A foot pedal may be used in a real life surgical environment because a surgeon does not have a free hand to manipulate the microscope. The user input from the foot pedal manipulates the camera in the virtual world. A sensor circuit board in the foot pedal obtains input from the foot pedal. The foot pedal controls aspects of the virtual microscope such as zoom, position, and focus.

In a preferred embodiment, the foot pedal's interface is a special class in the Universal Serial Bus (USB) standard known as the Human Interface Device (HID). In the software update loop, each button of the foot pedal is polled, and if the current state of a button does not match the previous state of the button, then a change has occurred. When a change has occurred, the appropriate code to manipulate the camera or simulation is called. Certain buttons, such as the zoom, focus, and joystick for panning, can be held down and constantly manipulate the camera until released. The foot pedal has a USB HID and the interface to the device does not require additional software drivers as all modern day operating systems have HID integrated into their basic operation.

Camera position and manipulation is based on the input given by the foot pedal. Movement of the joystick manipulates the X (up and down) and Y (right and left) planes in our virtual world. Pressing of the zoom in and zoom out rocker manipulates the Z plane (towards and away from the face). Several of the buttons may be programmed for special features. A button (preferably on the bottom-right of the pedal) may be used to auto-zoom the camera into a surgery-ready position. This saves time for the user because it eliminates zooming in and aligning the camera over the eye. An auto-zoom feature may be implemented so the user may complete more repetitions of the simulation.

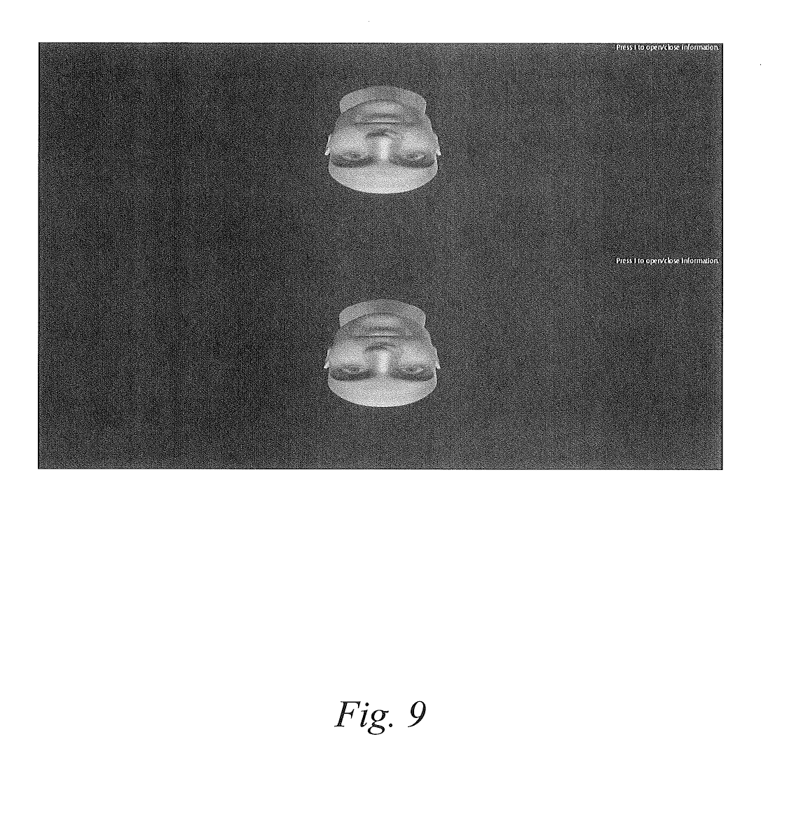

For graphics to appear three dimensional on a 3-dimensional screen, the implementation of additional viewports and cameras may be necessary. In an embodiment using a 3-dimensional screen, there can be two renderings of a simulation, a top and a bottom as shown in FIG. 9. Each rendering is half of the screen's size. Both the top and bottom view have an offset which can be adjusted via the focus rocker on the foot pedal. The field of view is wider than a normal simulation drawing. The wider field of view accounts for peripheral vision. The offset and change in field of view give the user an image may appears to pop off of the screen when wearing the appropriate 3-dimensional glasses or displayed on an appropriate display screen. The 3-dimensional monitor overlaps the top and bottom viewports.

A focus button manipulates the offset of camera in the upper 3-dimensional screen and the lower 3-dimensional screen. As shown in FIG. 9, the 3-dimensional screen is drawn top and bottom with a camera offset. When the offset is combined with the change in the field of view, the user perceives depth perception. If the offset is too much or too little, the image may appear blurry. The blur eliminates the need to use a Gaussian blur or other types of blur effects that require graphics post-processing. Graphics post-processing can cause a drop in frame rate which can create a bad user experience.

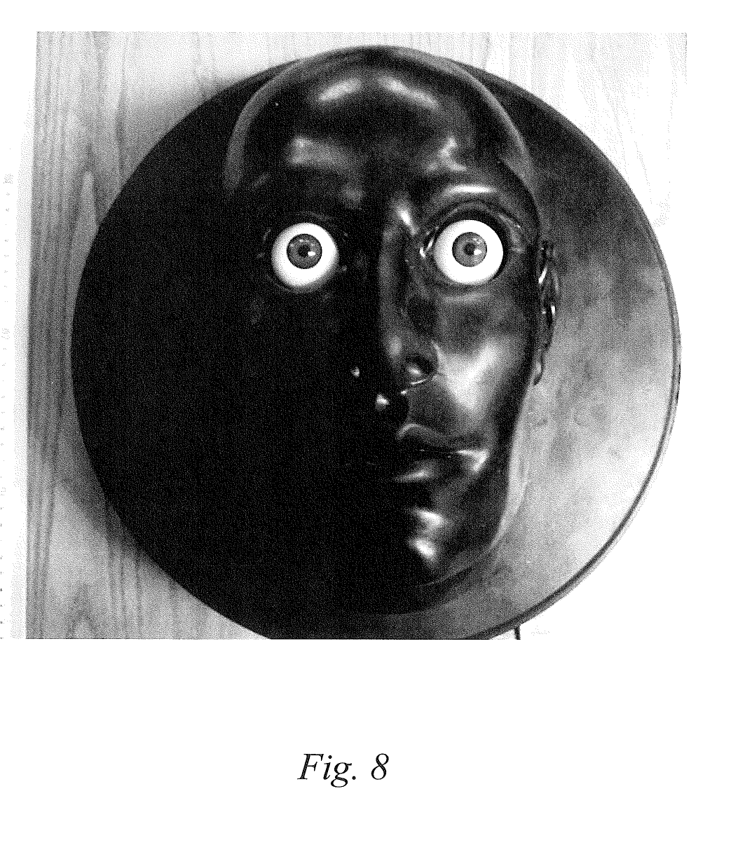

As shown in FIG. 8, the Universal Microsurgical Simulator may include a model of a human head and eyes that is used to provide correspondence between a model of a real life patient and the virtual representation of the human face in the microsurgical simulation. During surgery, surgeons often use parts of the head, such as the forehead, as a means of anchoring his or her hand. The head may be made of a durable mixture of polymers to provide a realistic model. The molded head can be made out of a blend of polymers with anti-stick properties. Different concentrations and thicknesses of the polymers can create the feel of human skin and bone structure.

The Universal Microsurgical Simulator may also include a touchscreen that allows a user to select tools and modify the surgery procedure based on inputs received. The touchscreen can also be used as the display for the surgery simulation itself or it may be a peripheral device in addition to a main display. Furthermore, the display may be a touchscreen or non-touchscreen device that provides three dimensional simulation capabilities.

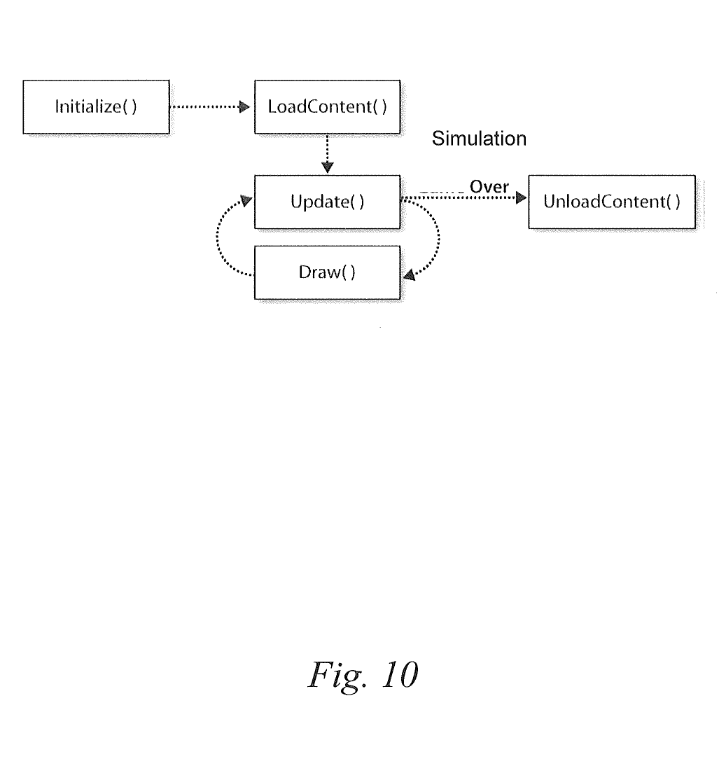

Virtual tools, or universal instruments, may be selected from a user interface and are drawn in the virtual simulation of the microsurgical environment as shown in FIG. 6. As discussed, a virtual representation 27 of the hand-held tool is drawn in the simulation based on the position and orientation of the 6-DOF sensor and tracking system. The model of each tool is rotated based on the distance between the attached tools, which may be given by an optical system or calculated based on changes in magnetic flux. As shown in FIG. 10, in an update loop of the software, the position, orientation, and tool distance rotation are updated. After initializing and loading content, the update loop of the simulation may be called 60 times per second. All the physics, input, mathematical calculations, and artificial intelligence take place in the update loop. When the update loop is over, if time is available, the draw loop will render the simulation to the screen.

Because the system needs to be capable of employing multiple instruments, there is a need to detect which hand-held tool is associated with the corresponding 6-DOF tracking sensor located in the structure of that hand-held tool. Each tool can be programmed with its own unique electronic serial number (ESN). An ESN for each tool allows that tool to be identified based on the assigned ESN. Programming the ESN for each tool can be done with a Windows-based diagnostic and maintenance program written by a software engineer. As an example, the ESN can be programmed into the Non-Volatile Random Access Memory (NVRAM) of a USB transceiver in the structure of a hand-held tool. The instrument then retains this serial number indefinitely unless reprogrammed. The simulation software is able to detect all available instruments, and allows each tool, based on serial number, to be associated with a specific sensor number on the 6-DOF tracking system.

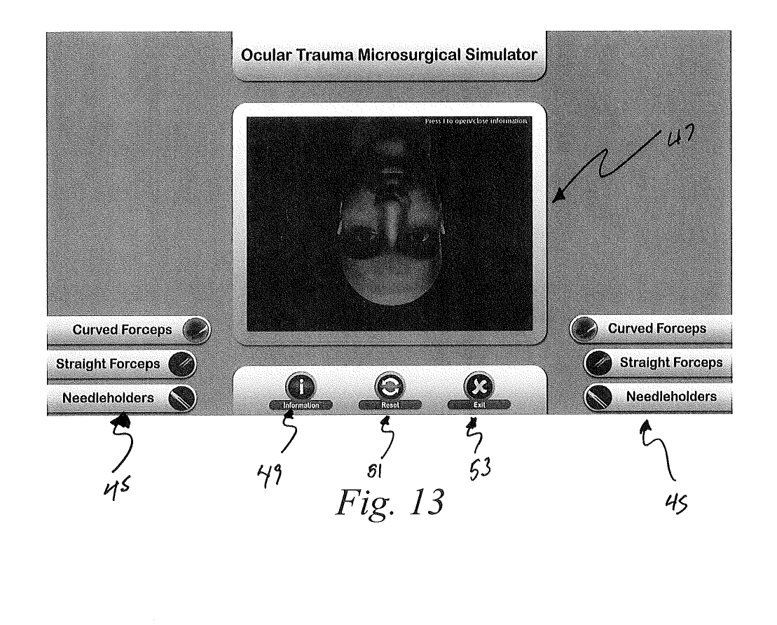

The simulation begins with a view of a virtual head on the display screen. The user is able to interact with a foot pedal to manipulate the camera and zoom in and focus on the eye. When the user is close enough to the eye, a lid speculum 43 is placed on the eye in the virtual simulation, as shown in FIG. 6. The lid speculum 43 holds the eye lids back and provides additional room for the surgeon to work. When the user is zoomed in, focused, and correctly positioned, he or she then picks up the tools and begins the surgery. During the surgery, the user can select different tools that are available via a user interface, such as that shown in FIG. 13, and displayed on a touchscreen or other selectable location. The user can then perform the training module provided, such as for example suturing.

Much or all of the software for the Universal Microsurgical Simulator can be programmed using the C# programming language. C# is an object-oriented, type-safe, mid to high level language. The C# programming language has automatic garbage collection, exception handling, and has a unified type system. The syntax of C# code is similar to Java and C++. C# also includes the .NET Framework and the XNA Framework. The syntax and features of C# made it a good choice for the creation of the ocular trauma microsurgical simulator, or microsurgical simulator in general.

Microsoft's XNA software package is a set of tools that allow game developers to quickly build games by eliminating the need to rewrite low-level code for graphics, input, and file management. Programmers can use Microsoft's XNA Framework to create robust, scalable, and interactive software with 3-dimensional graphics. Microsoft's XNA Game Studio is an integrated development environment (IDE) extension to Microsoft's Visual Studio. Microsoft's Visual Studio has several tools for programmers to quickly edit and format program code. One feature of the XNA Game Studio is the XNA content pipeline. XNA's content pipeline parses media (3-dimensional models for example) into a game ready format prior to the program execution. Media in a game ready format does not require specialized parsing during program execution and decreases the time to load media. Microsoft XNA is desirable for three reasons: 1) graphical capabilities 2) ease of receiving device input 3) ability to use existing .NET libraries.

Didactics are instructions that teach the user by displaying feedback on what they have done and should do next. The didactics combine the use of 2D and 3D graphics. The 2D graphics include a depth bar and feedback text. The 3D graphics include an insertion point. The depth bar shows the user the depth that his or her needle is in the eye compared to the desired depth. Feedback from our project surgeon, Dr. Joseph Sassani, was that one of the main issues that residents face was that they fail to put the needle in far enough to properly suture the eye injury. The feedback text provides information about the surgery in progress. Both the depth bar and feedback are in a heads up display (HUD). The insertion point directs the user where to place the needle next. The graphic for the insertion point is a round sphere. The insertion point sphere is placed in front of the eye at the desired needle insertion location.

A benefit of didactics is that the simulation program can narrow its focus of physics calculations, collision detection, and mesh manipulation. Narrowing the area of calculations increases the performance and efficiency of the simulation. The didactics display the depth of the needle of the operation and where the needle should be placed next.

In addition, the Universal Microsurgical Simulator may use a software library extension called the MUX Engine. For collision detection, a MUX Engine may be used. The MUX Engine has advanced model collision and vector and matrix manipulations and calculations that are not included in Microsoft XNA. The MUX Engine eliminates the need to rewrite calculations and reduces the chance of incorrect vector or matrix calculations.

The MUX Engine checks for model-to-model collision as well as ray-to-model collision. A ray is cast from the camera to check for collision against the face and eye models. When a collision occurs, the camera is not allowed to proceed in the direction of the collision (as it would go through a model or clip a model). If the camera clips a model or goes through a model, the user could enter unaccounted for areas of the simulator. The camera is bound to an area around the face, and cannot go further than two times the width of the face horizontally and the height of the face vertically.

During an ocular microsurgical simulation, the virtual eye is represented based on mathematical calculations that result in a mesh grid. The eye mesh grid is drawn by combining a series of textured triangle strips. The eye mesh grid is located in front of the eye in the virtual simulation. Typically, only the top layer of the eye mesh grid is drawn since the user will not see underneath the first layer of the eye mesh.

Hooke's law of elasticity can be used to simulate the pieces of the eye mesh. The mesh is a grid of points connected by invisible springs that allow for the simulation of real world forces and reactions. A force can be placed on any of the points of the eye mesh grid. Mesh manipulation based on string movement is based on a four point system to calculate forces. The insertion point of needle, exit point in the laceration, entrance point in the laceration, and exit point of needle are focus points. Forces are applied to the mesh through these four points and change the position of the points in the mesh grid that represents the eye. Changes in mesh positions are reflected in the drawing of the mesh.

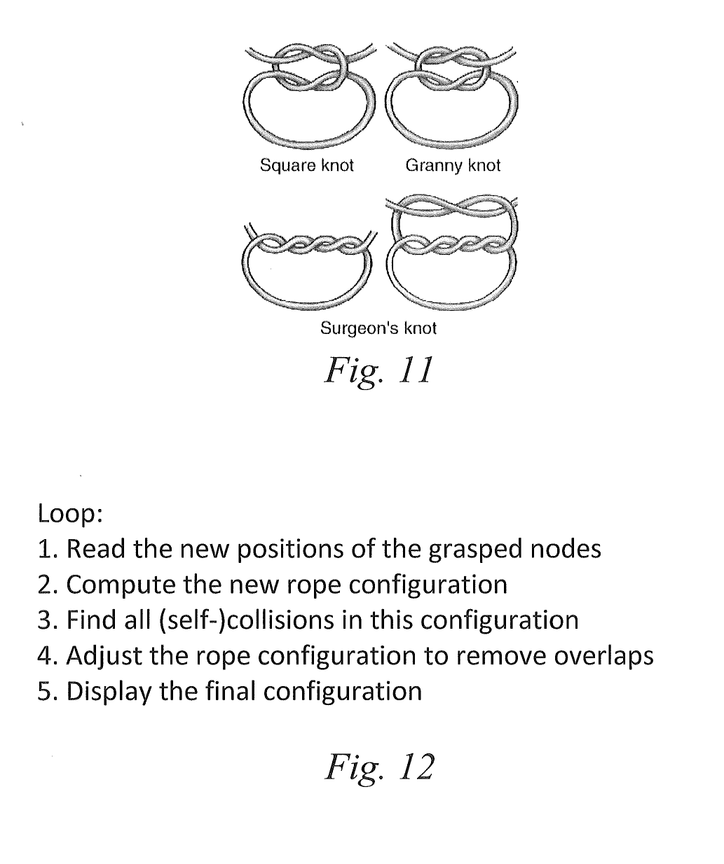

Accurately and efficiently simulating the string for knot tying is a crux of ocular microsurgery simulation. The string is drawn by rendering lines between the segments of the string. Each segment has a point and possibly a connecting neighbor. A line is rendered between neighbor segments. The simulator basically “connects the dots” between segments. The primary knot used in eye suturing surgery is the square knot. The Universal Microsurgical Simulator is able to determine if a user has created an appropriate square knot versus an inappropriate application of another knot, such as a granny knot. A granny knot is prone to slipping and is less stable than a square knot and can cause severe complications. FIG. 11 is an illustration of example surgical knots and the complexity of the knots is noted.

Because of the complex knot possibilities, software code based on Hooke's law of elasticity may be used with the Universal Microsurgical Simulator. If the code is based on Hooke's law, the simulation string will have realistic elasticity. The string can be simulated by combining 200 cylindrical segments. An algorithm for manipulation of the segments of the string is shown in FIG. 12.

The main objective of a user interface is for the user to easily select exactly what they want and receive a quick response from the program. An example of the layout of a touchscreen user interface of the Universal Microsurgical Simulator is provided in FIG. 13. This interface could also be implemented using a pointer device, such as a mouse. As seen in FIG. 13, in the center of the touchscreen is a view 47 of the current simulation in progress. At the bottom left and bottom right of the touchscreen view is the tool selection guide 45. Different tools may be displayed by picture and/or by text. In a touchscreen embodiment, the active tool image can be highlighted by touching the area of the tool image, text, or encompassing border, and the border, image, and text is moved slightly toward the center. A change in color and/or position may indicate which tool is currently selected.

Also shown in FIG. 13, at the bottom of the interface screen there are several utility buttons. An information button 49 represented by an ‘i’ gives the user information about the simulation software itself as well as basic information of the current simulation in progress. A reset button 51 is in the center of the utility buttons and is represented by a circular symbol. The reset button resets the entire simulation. Resetting allows the user to restart the simulation. An exit button 53 is represented by an “X”. The exit button shuts down the simulation and disposes all the resources involved in the simulation.

In addition, the software components and any hardware components that perform similar or the same functions of the Universal Microsurgical Simulator may be implemented on a local computer device or on a computer network. A host system may implement all aspects of the virtual simulation whereas the user of the physical tools that are modeled by the virtual simulation of the Universal Microsurgical Simulator may be located away from the host system at a client based system. For example, a client device may be in communication with the host system via a communications network. The communications network may be the Internet, although it will be appreciated that any public or private communication network, using wired or wireless channels, suitable for enabling the electronic exchange of information between the local computing device and the host system may be utilized.

Embodiments of the present disclosure also may be directed to computer program products comprising software stored on any computer useable medium. Such software, when executed in one or more data processing device, causes a data processing device(s) to operate as described herein. Embodiments of the present disclosure employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.), and communication mediums (e.g., wired and wireless communications networks, local area networks, wide area networks, intranets, etc.).

Accordingly, it will be appreciated that one or more embodiments of the present disclosure can include a computer program comprising computer program code adapted to perform one or all of the steps of any methods or claims set forth herein when such program is run on a computer, and that such program may be embodied on a computer readable medium. Further, one or more embodiments of the present disclosure can include a computer comprising code adapted to cause the computer to carry out one or more steps of methods or claims set forth herein, together with one or more apparatus elements or features as depicted and described herein.

As would be appreciated by someone skilled in the relevant art(s) and described above, part or all of one or more aspects of the methods and systems discussed herein may be distributed as an article of manufacture that itself comprises a computer readable medium having computer readable code means embodied thereon.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Although the invention is illustrated and described herein with reference to specific embodiments, the invention is not intended to be limited to the details shown. Rather, various modifications may be made in the details within the scope and range equivalents of the claims and without departing from the invention.

We claim:

1. A microsurgical simulation system comprising:
a display for providing a virtual simulation of images of a part of a simulated human to be subject to simulated microsurgery; and
a hand-held tool for simulating a surgical tool, the hand-held tool comprising a position and orientation sensor for supplying positional signals to a processor to indicate a position and orientation of the hand held tool and a tracking system for supplying measurement signals to the processor to indicate a linear distance between a first component and a second component of the hand-held tool; and
wherein a virtual representation of the hand-held tool is presented on the display, and the appearance and positioning of the virtual representation of the hand-held tool is based on the positional signals and measurement signals supplied to the processor by the hand-held device.

2. The microsurgical simulation system of claim 1, wherein the hand-held tool is forceps.

3. The microsurgical simulation system of claim 1, wherein the tracking system is a digital encoder.

4. The microsurgical simulation system of claim 3, wherein the digital encoder determines the linear distance between the first component and the second component of the hand-held tool based on contactless optical sensors attached to the hand-held tool.

5. The microsurgical simulation system of claim 1, further comprising a model of a human head.

6. The microsurgical simulation system of claim 1, further comprising a camera and a foot pedal, wherein the foot pedal controls the camera.

7. The microsurgical simulation system of claim 1, wherein said part of a simulated human to be subject to simulated microsurgery is an eye.

8. A microsurgical simulation tool comprising:
a hand-held tool for simulating a surgical tool, the hand-held tool comprising a position and orientation sensor for supplying positional signals to a processor to indicate a position and orientation of the hand held tool and a tracking system for supplying measurement signals to the processor to indicate a linear distance between a first component and a second component of the hand-held tool; and
wherein a virtual representation of the hand-held tool is presented on a display, and the appearance and positioning of the virtual representation of the hand-held tool is based on the positional signals and measurement signals supplied to the processor by the hand-held device.

9. The microsurgical simulation tool of claim 8, wherein the hand-held tool is forceps, tweezers, or needle holders.

10. The microsurgical simulation tool of claim 8, wherein the tracking system is a digital encoder.

11. The microsurgical simulation tool of claim 10, wherein the digital encoder determines the linear distance between the first component and the second component of the hand-held tool based on contactless optical sensors attached to the hand-held tool.
